(19) United States
(12) Patent Application Publication
(10) Pub. No.: US 2018/0239565 A1
(43) Pub. Date: Aug. 23, 2018

(54) DATA GENERATING DEVICE, DATA GENERATING METHOD, AND NON-TRANSITORY RECORDING MEDIUM STORING DATA GENERATING PROGRAM

(71) Applicants: Kazutaka YAMAMOTO, Kanagawa (JP); Yukari SUMITA, Tokyo (JP); Mutsuko NAGASHIMA, Tokyo (JP); Daisuke TEZUKA, Tokyo (JP)

(72) Inventors: Kazutaka YAMAMOTO, Kanagawa (JP); Yukari SUMITA, Tokyo (JP); Mutsuko NAGASHIMA, Tokyo (JP); Daisuke TEZUKA, Tokyo (JP)

(73) Assignee: Ricoh Company, Ltd., Tokyo (JP)

(21) Appl. No.: 15/553,232

(22) PCT Filed: Mar. 14, 2016
(86) PCT No.: PCT/JP2016/001445

§ 371 Date: Aug. 24, 2017

(30) Foreign Application Priority Data
Mar. 18, 2015 (JP) 2015-055416
Jan. 12, 2016 (JP) 2016-003740

(51) Int. Cl. G06F 3/12; B41J 2/475

(52) U.S. Cl. CPC G06F 3/1205; B41J 2/475; G06F 3/1255; G06F 3/1247; G06F 3/1208

(57) ABSTRACT

A data generating device is for generating writing data. The data generating device is connected to a writing device for writing a character on a recording medium based on the writing data. The data generating device includes an input unit configured to input the character and a layout, the layout being defined by a position, a size, and a range of writing the character; a calculation unit configured to calculate, in response to detecting that the character or the layout is changed, a writing time for writing by the writing device based on whether the character is to be written, an order of writing the character, and the layout; and an output unit configured to generate the writing data based on the character and the layout, and configured to output the generated writing data to the writing device.

### TECHNICAL FIELD

The present invention relates to a data generating device, a data generating method, and a data generating program.

### BACKGROUND ART

A method of writing information on a container has been known. In the method, a label is attached to a container, and an address and a product name are written on the label, or combinations of addresses and product names are written on the label. If the label is formed of thermo-sensitive paper, upon applying heat to a portion of the label, the color of the portion of the label is changed. By using this fact, text, a symbol, and/or a combination thereof can be written on the label by applying heat.

For writing on a label by a laser beam, the laser beam is irradiated onto the label along a drawing line. Thus, for painting out an area on the label, the area to be painted is divided into a plurality of lines, and the laser beam is irradiated along each of the plurality of lines. Thus, for transitioning from a drawing end point of a line to a drawing start point of a next line, irradiation of the laser beam is temporarily interrupted. Upon transitioning to the drawing start point of the next line, irradiation of the laser beam is started after the temperature of a laser source is increased to the drawing temperature again. In this manner, a drawing time (i.e., a time period required for drawing) may be elongated. In this regard, a method of reducing the drawing time while enhancing the quality of drawing has been known such that drawing is executed by reversing the direction of drawing on a line-by-line basis (namely, the direction of drawing is reversed for a line adjacent to the line that is currently drawn) (cf. Patent Document 1, for example).

In a usual device, a user creates drawing data by using an input unit of the device. In such a case, upon receiving an instruction from the user who creates the drawing data, a time period required for drawing is calculated based on the created drawing data, and the calculated drawing time is displayed.

### SUMMARY OF INVENTION

### Technical Problem

However, in many cases, for causing the device to calculate a time period for writing on a recording medium (which is referred to as the writing time, hereinafter), a user is required to intentionally input an instruction for causing the device to calculate the writing time. If the user causes the device to calculate the writing time after completing input of the writing data, the user may find that the writing time is too long. Thus, the user may be required to create the writing data again. With a usual device, it may be difficult to find, in response to detecting that the writing data is changed, the writing time prior to execution of writing, so as to sequentially correct the writing data.

There is a need for a data generating device that can calculate, in response to detecting that writing data is changed, writing time prior to writing a letter, a number, a figure, a symbol, a barcode, a two-dimensional code, or a combination thereof (which is referred to as the character, hereinafter).

### Solution to Problem

According to an aspect of the present invention, there is provided a data generating device for generating writing data, wherein the data generating device is connected to a writing device for writing a character on a recording medium based on the writing data. The data generating device includes an input unit configured to input the character and a layout, the layout being defined by a position, a size, and a range of writing the character; a calculation unit configured to calculate, in response to detecting that the character or the layout is changed, a writing time for executing writing by the writing device based on whether the character is to be written, an order of writing the character, and the layout; and an output unit configured to generate the writing data based on the character and the layout, and configured to output the writing data to the writing device.

According to another aspect of the present invention, there is provided a data generating method to be executed by a data generating device for generating writing data. The data generating device is connected to a writing device for writing a character on a recording medium based on the writing data. The data generating method includes inputting, by the data generating device, the character and a layout, the layout being defined by a position, a size, and a range of writing the character; calculating, by the data generating device, a writing time for writing by the writing device based on whether the character is to be written, an order of writing the character, and the layout, in response to detecting that the character or the layout is changed; and generating, by the data generating device, the writing data based on the character and the layout, and outputting, by the data generating device, the generated writing data to the writing device.

According to another aspect of the present invention, there is provided a data generating program for causing a computer to generate writing data. The computer is connected to a writing device for writing a character on a recording medium based on the writing data. The data generating program is for causing the computer to execute a step of inputting, by the computer, the character and a layout, the layout being defined by a position, a size, and a range of writing the character; a step of calculating, by the computer, a writing time for writing by the writing device based on whether the character is to be written, an order of writing the character, and the layout, in response to detecting that the character or the layout is changed; and a step of generating, by the computer, the writing data based on the character and the layout, and outputting, by the computer, the generated writing data to the writing device.

### Advantageous Effects of Invention

A data generating device according to an embodiment can calculate, in response to detecting that writing data is changed, writing time prior to writing a character.

### BRIEF DESCRIPTION OF DRAWINGS

FIG. 1 is a configuration diagram illustrating an example of an overall configuration of an information processing system according to an embodiment of the present invention;

FIG. 2 is a diagram illustrating an example of a recording medium according to the embodiment of the present invention;

FIG. 3 is a block diagram illustrating an example of a hardware configuration of a writing device according to the embodiment of the present invention;

FIG. 4 is a block diagram illustrating an example of a hardware configuration of a whole controller included in the writing device according to the embodiment of the present invention;

FIG. 5 is a block diagram illustrating an example of a hardware configuration of a data generating device according to the embodiment of the present invention;

FIG. 6 is a block diagram illustrating an example of a hardware configuration of each of a first reading device and a second reading device according to the embodiment of the present invention;

FIG. 7 is a flowchart illustrating an example of a whole process by the data generating device according to the embodiment of the present invention;

FIG. 8A is a diagram illustrating an example of writing by the writing device according to the embodiment of the present invention;

FIG. 8B is a diagram illustrating the example of writing by the writing device according to the embodiment of the present invention;

FIG. 9A is a diagram illustrating an example of a scanning instruction used for the writing device according to the embodiment of the present invention;

FIG. 9B is a diagram illustrating an example of a scanning instruction used for the writing device according to the embodiment of the present invention;

FIG. 10 is a diagram illustrating an example of displaying a screen of the whole process by the data generating device according to the embodiment of the present invention;

FIG. 11 is a functional block diagram illustrating an example of a functional configuration of the data generating device according to the embodiment of the present invention;

FIG. 12 is a flowchart illustrating an example of the whole process by the data generating device according to another embodiment of the present invention;

FIG. 13 is a diagram illustrating an example of displaying the screen of the whole process by the data generating device according to the other embodiment of the present invention; and

FIG. 14 is a functional block diagram illustrating an example of the functional configuration of the data generating device according to the other embodiment of the present invention.

### DESCRIPTION OF EMBODIMENTS

Embodiments of the present invention are described below.

(An Embodiment)

(An Example of a Whole Configuration)

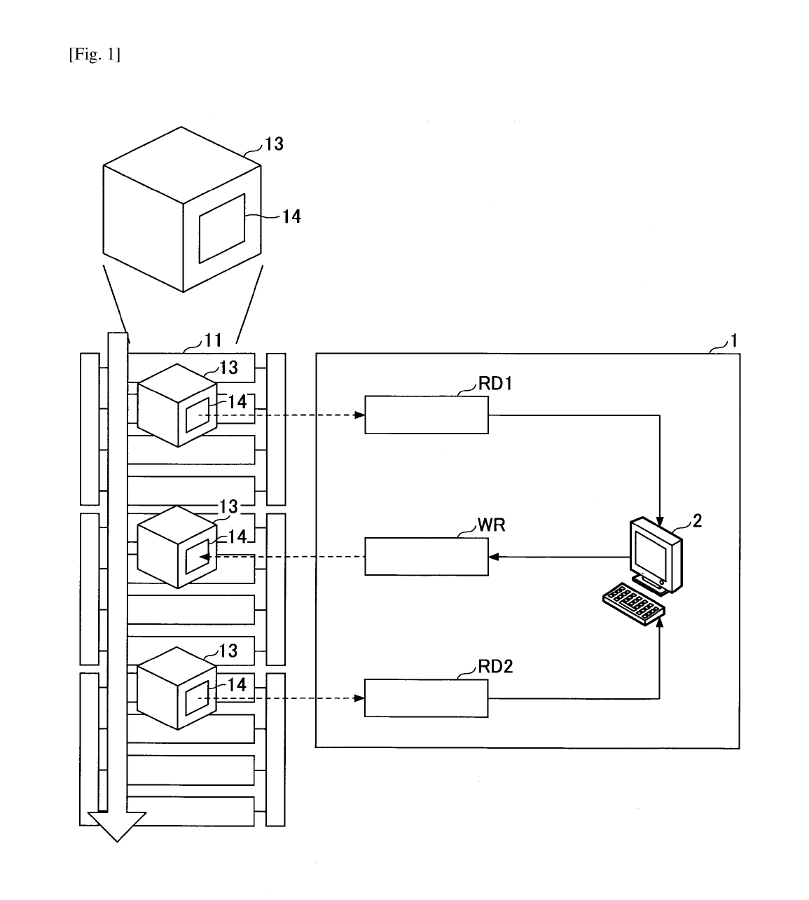

FIG. 1 is a configuration diagram illustrating an example of a whole configuration of an information processing system 1 according to the embodiment of the present invention. Specifically, the information processing system 1 includes a reader (RD) 1 as an example of a first reading device; a laser writing device (WR) as an example of a writing device; and a reader (RD) 2 as an example of a second reading device. Additionally, the information processing system 1 includes a personal computer (PC) 2 as an example of a data generating device. In the information processing system 1, the PC 2 is connected to each of the RD 1, the laser writing device WR, and the RD 2.

Further, as depicted, it is assumed that a container, such as a corrugated cardboard box, a wooden box, or a plastic case, is conveyed by a conveyance device, such as a conveyor 11. In an example described below, it is assumed that the container to be conveyed is a container 13 in FIG. 1. Further, in the following example, it is assumed that the container 13 is conveyed on the conveyor 11 from an upstream position where the reader RD 1 is disposed to a downstream position where the reader RD 2 is disposed through a position where the laser writing device WR is disposed.

The container 13 includes, for example, a thermo-sensitive recording medium 14 that changes color depending on temperature so as to display an address of a product, a product name, a product number, an addressee's name, and/or a combination thereof (which is called the address, hereinafter). In the information processing system 1, information is written in the thermo-sensitive recording medium 14, and information is read out from the thermo-sensitive recording medium 14. Here, the thermo-sensitive recording medium 14 may be a label or a sheet of rewritable paper.

The thermo-sensitive recording medium 14 may be adhered to the container 13. Alternatively, the thermo-sensitive recording medium 14 may be detachably attached to the container 13. After information is written on the thermo-sensitive recording medium 14, the thermo-sensitive recording medium 14 may be recognized as a label by a person. In the conveyor 11, the laser writing device WR is disposed at a position facing the thermo-sensitive recording medium 14. In response to detecting that the container 13 is passing through the laser writing device WR, for example, by using a sensor, the laser writing device WR writes, on the thermo-sensitive recording medium 14, the character indicating the address, for example.

Subsequently, in the information processing system 1, the reader RD 2 confirms the character written on the thermo-sensitive recording medium 14 by the laser writing device WR.

The information processing system 1 may further include a server or an information processing device, such as a personal computer (PC) 2. The PC 2 may be formed of a plurality of computers.

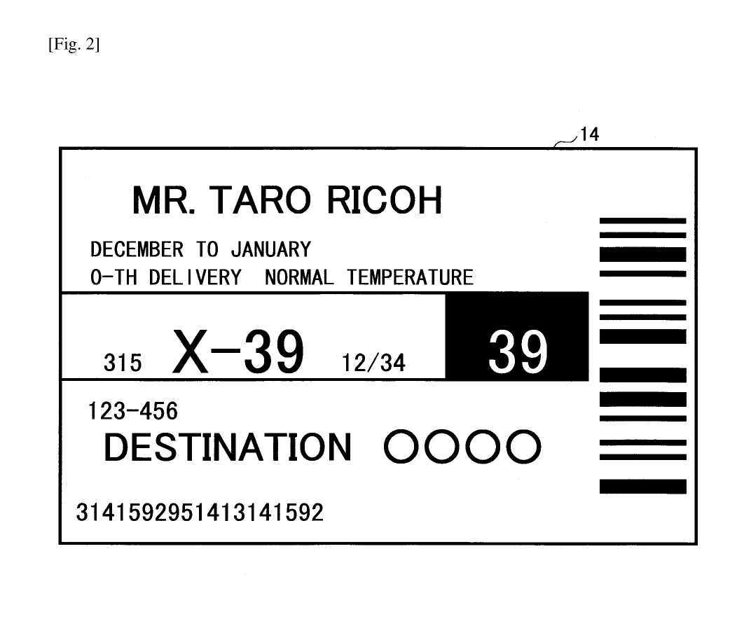

FIG. 2 is a diagram illustrating an example of the thermo-sensitive recording medium 14 according to the embodiment.

The laser writing device WR (cf. FIG. 1) writes the character, such as the characters illustrated in FIG. 2, on the thermo-sensitive recording medium 14. Specifically, the laser writing device WR writes the character by irradiating a laser beam onto the thermo-sensitive recording medium 14. Here, the laser beam may preferably be a spot light beam that is condensed by a lens, so that complicated characters can be written. Thus, the laser writing device WR that emits the laser beam controls a position at which the laser beam is irradiated, so that a stroke, such as characters, can be followed by a spot light beam.

Note that, among the characters, the two-dimensional code may be, for example, QR code (registered trademark), the two-dimensional code of a matrix type (e.g., DataMatrix), or the two-dimensional code of a stack type (e.g., PDF 417).

(Example of the Hardware Configuration of the Laser Writing Device)

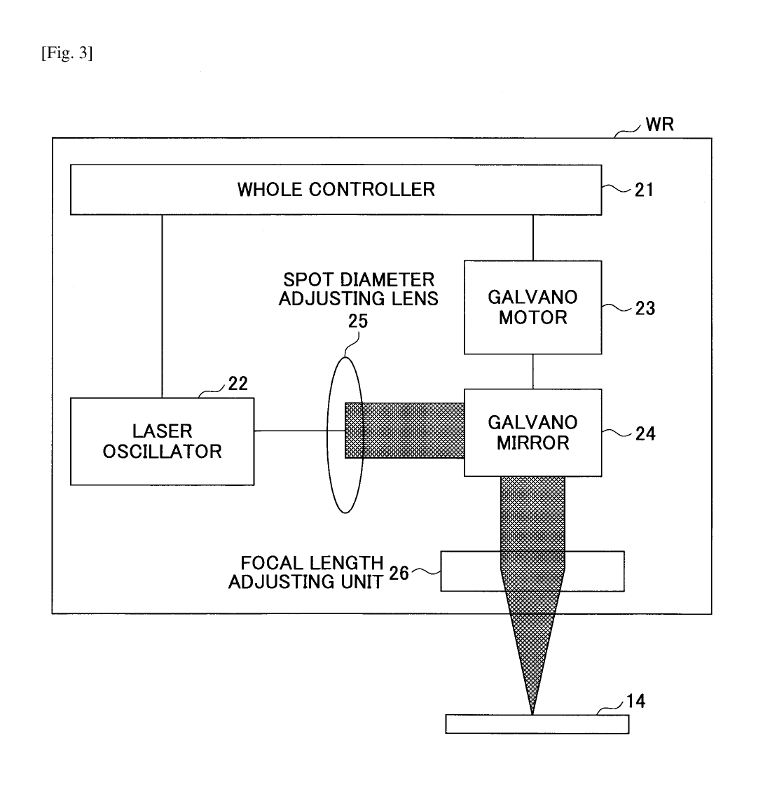

FIG. 3 is a block diagram illustrating an example of a hardware configuration of the laser writing device WR according to the embodiment of the present invention. Specifically, the laser writing device WR may include a whole controller 21; a laser oscillator 22; a galvano motor 23; a galvano mirror 24; a spot diameter adjusting lens 25; and a focal length adjusting unit 26.

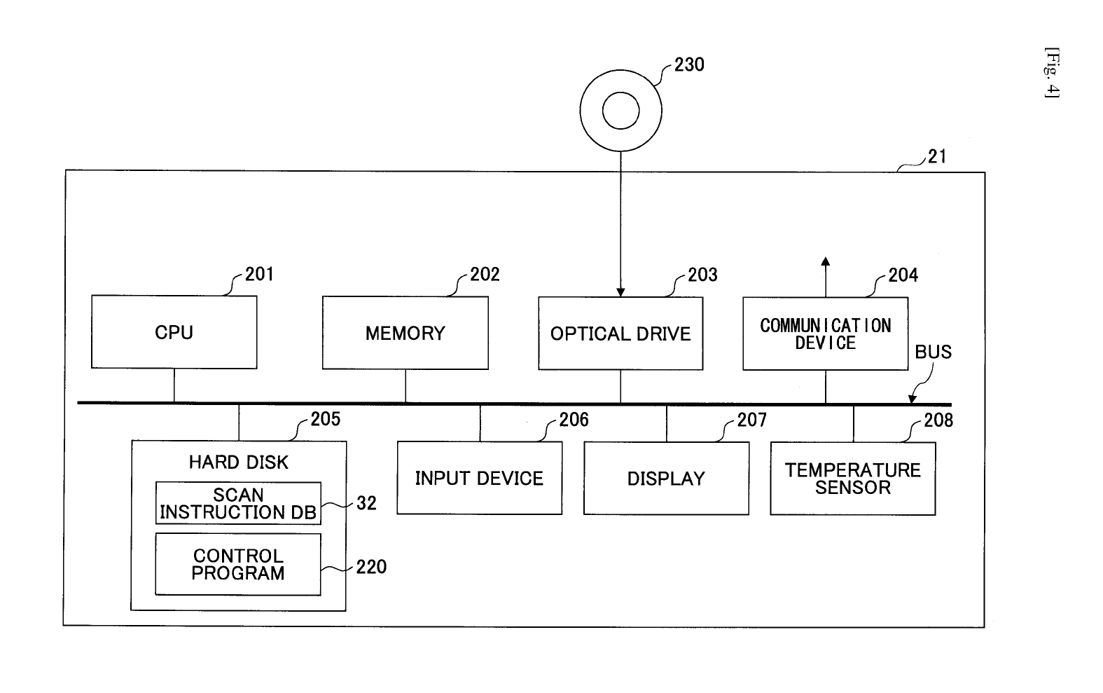

FIG. 4 is a block diagram illustrating an example of a hardware configuration of the whole controller 21 included in the laser writing device WR according to the embodiment. Specifically, the whole controller 21 may include a central processing unit (CPU) 201; a memory 202; an optical drive 203; a communication device 204; a hard disk 205; an input device 206; a display 207; and a temperature sensor 208. Further, the hard disk 205 stores a scan instruction data base (DB)32 that stores a scan instruction for writing the text. Further, the hard disk 205 stores a control program 220 for controlling the laser oscillator 22 (FIG. 3) and the galvano motor 23 (FIG. 3) in accordance with the scan instruction.

The CPU 201 reads out the control program 220 from the hard disk 205 and executes the control program 220 so as to write the character on the thermo-sensitive recording medium 14 (FIG. 1). Namely, the CPU 201 is a controller and a processor.

The memory 202 is a volatile memory, such as a dynamic random access memory (DRAM). The memory 202 can be a work area for the CPU 201 to execute the control program 220.

The optical drive 203 is configured so that a storage medium 230 can be detachably attached to the whole controller 21. The optical drive 203 can be used for reading out data from the storage medium 230, and for writing data in the storage medium 230.

The communication device 204 may be, for example, an Ethernet (registered trademark) card, a serial communication device (Universal Serial Bus (USB) device), an IEEE 1394-based device, or a Bluetooth (registered trademark) device. Further, the communication device 204 can be used for transmitting data to or receiving data from an external device.

The hard disk 205 is an example of an auxiliary storage device for storing data, parameters, and/or one or more programs, which are to be used by the whole controller 21.

The input device 206 may be, for example a mouse and a keyboard. The input device 206 is a device for a user to input an instruction for controlling the laser writing device WR (FIG. 3).

The display 207 is a user interface for displaying, for example, a graphical user interface (GUI) screen with a resolution and a number of colors based on screen information instructed by the control program 220, for example. The display 207 may display, for example, an input field for inputting the character, which is to be written on the thermo-sensitive recording medium 14.

The temperature sensor 208 periodically measures environmental temperature of the laser writing device WR, and the temperature sensor 208 outputs the measured temperature to the CPU 201.

The control program 220 may be distributed in a state where the control program 220 is stored in the storage medium 230. The control program 220 may be read out from the storage medium 230, and the control program 220 is installed in the hard disk 205. Here, the control program 220 may be downloaded from, for example, a server that is connected to the whole controller 21 through a network.

The storage medium 230 is a detachable and portable non-volatile memory, such as a DVD-ROM, a Blue-ray disk, an SD (registered trademark) card, a multimedia card, or a xD card.

Referring back to FIG. 3, the laser oscillator 22 is a semiconductor laser (a laser diode (LD). Alternatively, the laser oscillator 22 may be a gas laser, a solid state laser, or a liquid laser, for example.

The galvano motor 23 may be, for example, servo motors for controlling a direction of a reflection surface of the galvano mirror 24 with two axes.

The galvano mirror 24 is an example of a direction control minor. The galvano mirror 24 may be another mirror as long as the direction can be controlled. For example, the galvano mirror 24 may be a Micro Electro Mechanical Systems (MEMS) mirror.

The spot diameter adjusting lens 25 is a lens for magnifying a spot diameter of a laser beam. The focal length adjusting unit 26 is a lens for adjusting the focal distance by converging a laser beam. Further, the focal length adjusting unit 26 adjusts the focal distance depending on the distance from the laser oscillator 22, which is a light source, to the position on the thermo-sensitive recording medium 14 at which the laser beam is irradiated. Here, it can be said that the focal length adjusting unit 26 adjusts the focal length depending on the distance from the laser writing device WR because the position of the laser oscillator 22 is fixed.

Note that the writing device is not limited to the writing device that emits a laser beam, such as the laser writing device WR. For example, the writing device may be a label printer or a thermal printer that executes printing by causing a recording medium to develop color by pressing a heated head to the recording medium. Alternatively, the writing device may be a laser process machine that engraves a recording medium by irradiating a laser beam onto the recording medium.

(Example of Recording Medium)

The thermo-sensitive recording medium 14 (FIG. 2) includes, for example, four layers in a depth direction from the surface, which are a protection layer, a recording layer including a reversible thermo-sensitive recording film, a base material layer, and a back coat layer. Further, the thermo-sensitive recording medium 14 is formed to have flexibility and a certain extent of a strength property, so that the thermo-sensitive recording medium 14 can be repeatedly used. The thermo-sensitive recording medium 14 may be referred to as a thermo-sensitive paper sheet. However, the thermo-sensitive recording medium 14 may not be formed of only a plant fiber. The thermo-sensitive recording medium 14 may not include a plant fiber.

In a part of the thermo-sensitive recording medium 14, a rewritable display area is formed, as a rewritable reversible area. Such a thermo-sensitive recording medium 14 may be referred to as a rewritable paper sheet. Further, the rewritable display area is formed of a reversible thermo-sensitive recording medium, such as a thermo-chromic film. The types of the reversible thermo-sensitive recording media include a type of the reversible thermo-sensitive recording medium such that a degree of transparency reversibly changes depending on temperature; and a type of the reversible thermosensitive recording medium such that a color tone reversibly changes depending on temperature.

An example is described below where the thermo-sensitive recording medium 14 includes a thermo-chromic film such that the color tone reversibly changes depending on temperature, and that achieves a rewritable property by including a leuco dye and a developer in the recording layer.

For example, when a part of or all the thermo-sensitive recording medium 14 is heated from a decolorized state to above a melting point (e.g., approximately 180° C.), the heated portion is rapidly cooled from a melting state where the leuco dye and the developer of the thermo-sensitive recording medium 14 are mixed. Thus, the color of the pat of or all the thermo-sensitive recording medium 14 changes to black color, for example. In this case, in the thermo-sensitive recording medium 14, the dye and the developer are condensed while the dye and the developer are bonded. In this manner, in the thermo-sensitive recording medium 14, the dye and the developer form a state where the dye and the developer are systematically collected to some extent. Thus, the state is fixed where the color of the thermo-sensitive recording medium 14 is changed.

Whereas, when the part of or all the thermo-sensitive recording medium 14 is heated to a temperature at which the colorized state is not melted (e.g., from 130° C. to 170° C.), the colorized collected state collapses, and the developer is crystallized along and separated, so that the state becomes the decolorized state. Namely, when the part of or all the thermo-sensitive recording medium 14 is heated to the temperature at which the colorized state is not melted, the character that is written on the thermo-sensitive recording medium 14 is deleted. Here, the leuco dye is color-less or light-colored dye precursor. The leuco dye is not particularly limited, and the leuco dye can be suitably selected from known materials.

Note that the color change includes not only appearance of a visible shape including color information, but also appearance of a shape without color information. For example, the color change includes the fact that the white thermo-sensitive recording medium 14 changes to black, and the fact that the black thermo-sensitive recording medium 14 changed to white.

Further, it is not necessary that the thermo-sensitive recording medium 14 is rewritable. The thermo-sensitive recording medium 14 may be a write-once type thermo-sensitive recording medium (i.e., a type of thermo-sensitive recording medium such that once the character is written, the character can not be deleted).

Here, the size of the thermo-sensitive recording medium 14 is A4 size, for example. However, the size of the thermo-sensitive recording medium 14 may be suitably adjusted.

Each of the thermo-sensitive recording medium 14 and the container 13 (FIG. 1) has a service life, which depends on the number of times writing. It is assumed that, upon expiration of the service life, each of the thermo-sensitive recording medium 14 and the container 13 is replaced or repaired.

Furthermore, the target to be written is not limited to the recording medium. For example, if the writing device WR is a laser process machine, the target to be written may be a product which is to be engraved.

(Example of the Hardware Configuration of the Data Generating Device)

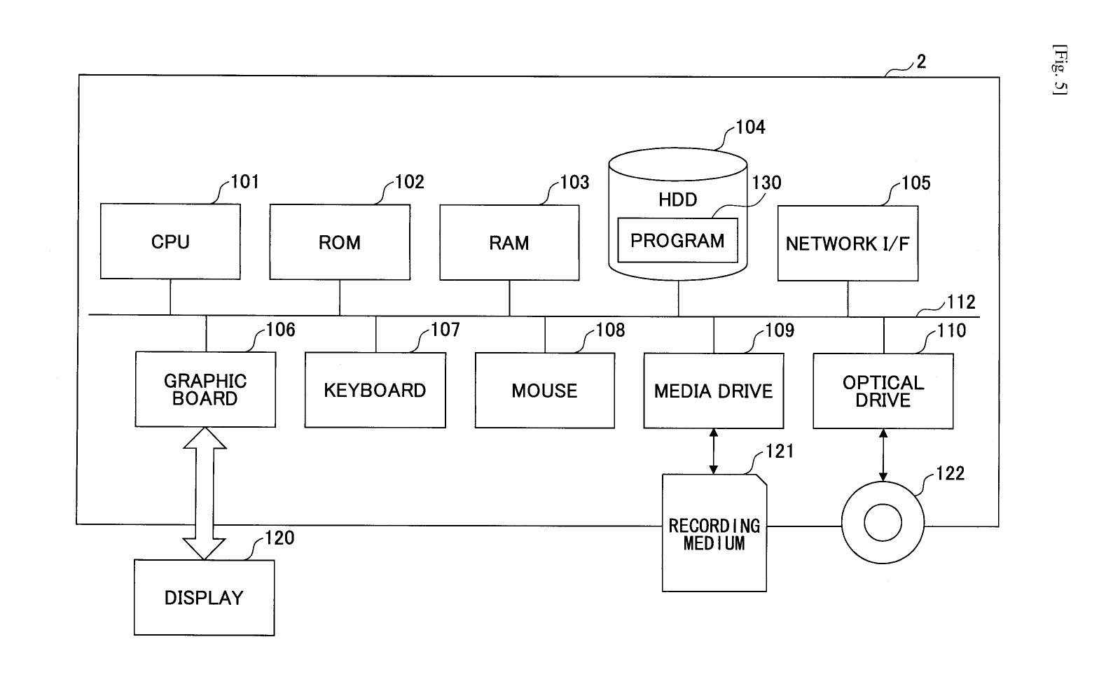

FIG. 5 is a block diagram illustrating an example of a hardware configuration of the data generating device 2 according to the embodiment. As the PC 2, a general-purpose information processing device can be used. Here, examples of the information processing device 2 include a personal computer (PC), a work station, a tablet PC, a server, a smartphone, and so forth. However, the information processing device 2 may be referred to by a different name. In the following, an example is described where the data generating device 2 is a personal computer.

The PC 2 may include, for example, a CPU 101; a read-only memory (ROM) 102; a random access memory (RAM) 103; a hard disk drive (HDD) 104; a network interface (I/F) 105; a graphic board 106; a keyboard 107; a mouse 108; a media drive 109; and an optical drive 110.

The CPU 101 controls overall operation of the PC 2 by executing a program 130 stored in the HDD 104. Namely, the CPU 101 is a controller and a processor.

The ROM 102 stores, for example, an initial program loader (IPL) and static data.

The RAM 103 is an example of a main storage device that can be used by the CPU 101 as a work area for executing the program 130.

The HDD 104 stores the program 130 and an operating system (OS) that are to be executed by the CPU 101. The program 130 is the program for generating a scan instruction to the laser writing device WR from information on a shape of a figure, such as peaks and frame lines. Namely, based on the program 130, the PC 2 transmits, to the laser writing device WR, data indicating the character, which is to be written by the laser writing device WR. Subsequently, upon receiving the data indicating the character, the laser writing device WR generates the scan instruction from the information on the shape of the figure, such as the peaks and the frame lines, so as to write the character. Here, the PC 2 may generate a part of or all the scan instruction, and the PC 2 may transmit generated data indicating the scan instruction to the laser writing device WR.

The network I/F 105 may be, for example, an Ethernet (registered trademark) card for establishing a connection to a network, and the network I/F 105 mainly executes a layer 1 process and a layer 2 process. Further, a process above the layer 3 can be executed by a protocol stack and program of the transmission control protocol/Internet Protocol (TCP/IP), which are included in the OS.

The graphic board 106 parses a drawing command that is written by the CPU 101 in a video RAM, and the graphic board 106 displays various types of information, such as s window, a menu, a cursor, a character, or an image, on the display 120.

The keyboard 107 includes a plurality of keys for a user to input characters, numbers, and instructions. The keyboard 107 receives operation by a user, and the keyboard 107 reports the operation to the CPU 101. Similarly, the mouse 108 receives operation by a user, such as operation to move a cursor, operation to select a menu item, and operation related to processing details.

The media drive 109 controls a process of reading out data from or writing (storing) data in the recording medium 121, such as a flash memory.

The optical drive 110 controls a process of reading out various types of dada from or writing various types of data in the optical medium 122, such as a CD-R and a DVD-RW, as an example of a detachable recording medium. Further, the PC 2 includes a bus line 112, such as an address bus and a data bus, for electrically connecting the hardware components.

The program 130 can be recorded in the computer readable recording medium 121 or the computer readable optical medium 122 as a file in a installable format or in an executable format, and the program 130 can be distributed by distributing the recording medium 121 or the optical medium 122. Alternatively, the program 130 may be distributed from a server to the PC 2 as a file in an installable format or a file in an executable format.

(Examples of Hardware Configurations of the First Reading Device and the Second Reading Device)

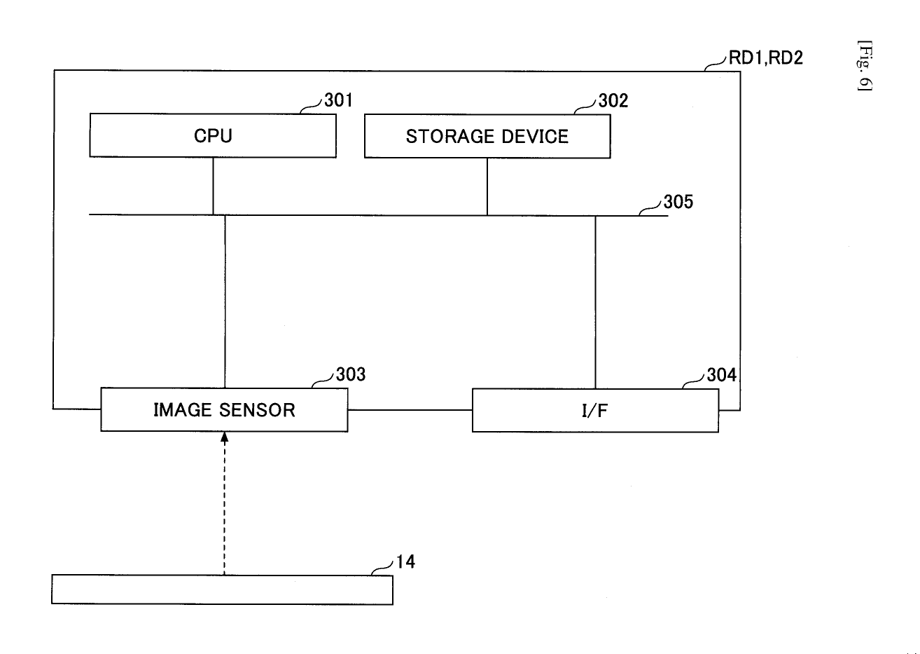

FIG. 6 is a block diagram illustrating an example of a hardware configuration of the first reading device RD 1 and the second reading device RD 2 according to the embodiment. For example, the hardware configuration of the reader RD 1 may be the same as the hardware configuration of the reader RD 2. The example of the hardware configuration of the reader RD 1 is described below.

The reader RD 1 may be an image processing device including a barcode reader, or a camera; or the reader RD 1 may be a system in which the barcode reader and the camera are combined. Note that the reader RD 1 may be changed depending on a type of the character written on the thermo-sensitive recording medium 14 (FIG. 1).

The reader RD 1 may include, for example, a CPU 301; a storage device 302; an image sensor 303; and an I/F 304. Further, the hardware components included in the reader RD 1 are connected by a bus 305.

The CPU 301 controls overall operation of the reader RD 1 by executing a program stored in the storage device 302. Namely, the CPU 301 is a controller and a processor.

The storage device 302 is a memory, for example. The storage device is an example of a main storage device that can be used by the CPU 301 as a work area for executing a program. Here, the storage device 302 may include an auxiliary storage device, such as a hard disk drive.

The image sensor 303 can be a camera, for example. The image sensor 303 generates image data, which represents the character written on the thermo-sensitive recording medium 14.

The I/F 304 may be, for example, a connector and a processing integrated circuit (IC) for establishing a connection to an external device (e.g., PC 2) through a network or a cable (e.g. RS-232C).

The reader RD 1 analyzes the character written on the thermo-sensitive recording medium 14 by applying an optical character recognition (OCR) process to the image data generated by the image sensor 303, for example. Next, the reader RD 1 generates text data or image data representing the character written on the thermo-sensitive recording medium 14, and the RD 1 transmits the generated text data or image data to the external device (e.g., the PC 2 (FIG. 1)) through the I/F 304.

(Example of the Whole Process)

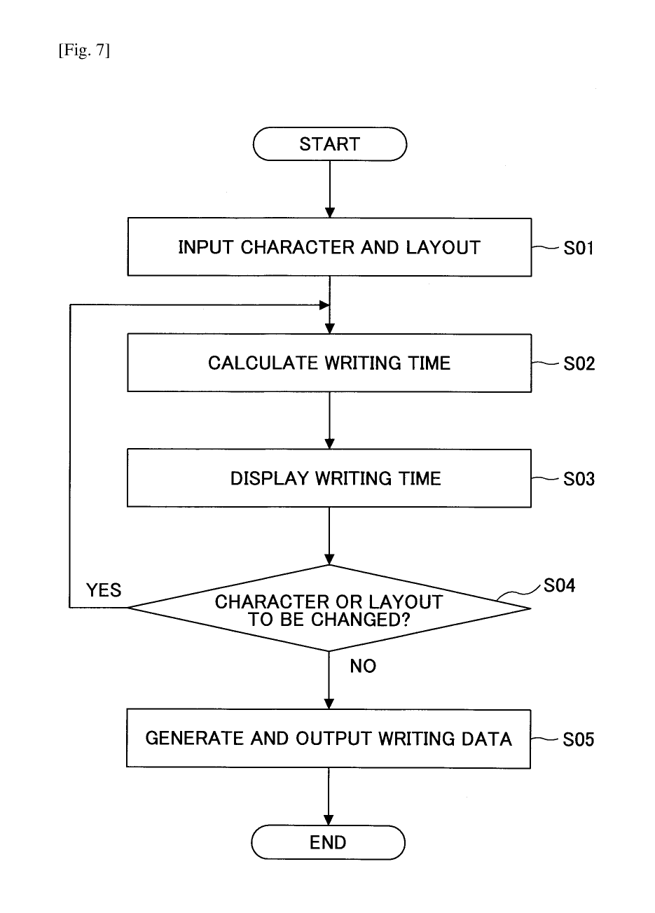

FIG. 7 is a flowchart illustrating an example of the whole process executed by the data generating device 2 according to the embodiment.

(Example of Inputting the Character and the Layout (Step S01))

At step S01, the PC 2 (FIG. 1) inputs the character and the layout that is defined by the position, the size, and the range of writing the character (which is simply referred to as the layout, hereinafter). Specifically, at step S01, the PC 2 displays, for example, a graphical user interface (GUI), and the PC 2 prompts a user to input a type of the character to be written on the thermo-sensitive recording medium 14 and the layout. Here, the PC 2 may read data indicating the character and the layout.

Additionally, with regard to the writing speed and characters, a writing condition, which includes a setting value for setting writing speed specifying speed of writing a predetermined character, may be input to the laser writing device WR. Note that the writing condition may be input for each character. Specifically, writing speed for writing the whole information is set in the laser writing device WR, as the writing condition. Next, for writing a predetermined type of character, writing speed for writing the predetermined type of character is set, as a setting value. Then, upon determining that the predetermined character is to be written, the laser writing device WR writes the predetermined character with the writing speed that is specified by the setting value. Whereas, upon determining that a character other than the predetermined character is to be written, the laser writing device WR writes the character with the writing speed for writing the whole information. Namely, the writing condition may be input to the laser writing device WR, so that, among characters to be written, the writing speed for writing a part of the characters can be changed. If the writing condition is input in this manner, the writing time can be accurately calculated. Note that the writing condition may be input to the laser writing device WR in advance.

(Example of Calculating the Writing Time (Step S02))

At step S02, the PC 2 calculates the writing time. Specifically, at step S02, PC 2 calculates the writing time based on the character and the layout input at step S01, namely, based on whether the character is to be written, an order of writing the character, and the layout.

Here, the layout can be defined, for example, by the character, the position where the character is to be written, the size of the character, and a range of writing the character. Additionally, the layout may be defined by a writing condition, for example.

For example, a correction value may be set in the writing condition. An example is described below where a correction value is set in the writing condition. The correction value can be a value for changing a specification of the laser writing device WR.

Specifically, in the laser writing device WR, the writing speed for writing the whole information is set in the writing condition. The writing condition may be input for each layout or for each character, for example. Next, as a correction value, a correction coefficient is input, which is for changing a value that is input in the writing condition.

A case where the writing speed for writing the whole information is set to “100” is described below, as an example of using the correction coefficient. Suppose that a correction coefficient of “110%” is input as a writing condition for writing a specific character, while assuming that the writing speed for writing the whole information is set to “100.” In this case, the writing speed for writing the specific character can be calculated as “100×110%=110.” Based on the result of the calculation, the laser writing device WR writes the specific character with the writing speed of “110.” In this manner, if, for each character, a condition for writing the character is defined in the writing condition, the laser writing device WR can set the condition for writing in detail. Note that the setting value is not limited to the correction value, such as the correction coefficient. For example, writing speed for writing a predetermined character may be input as “100” or “200.”

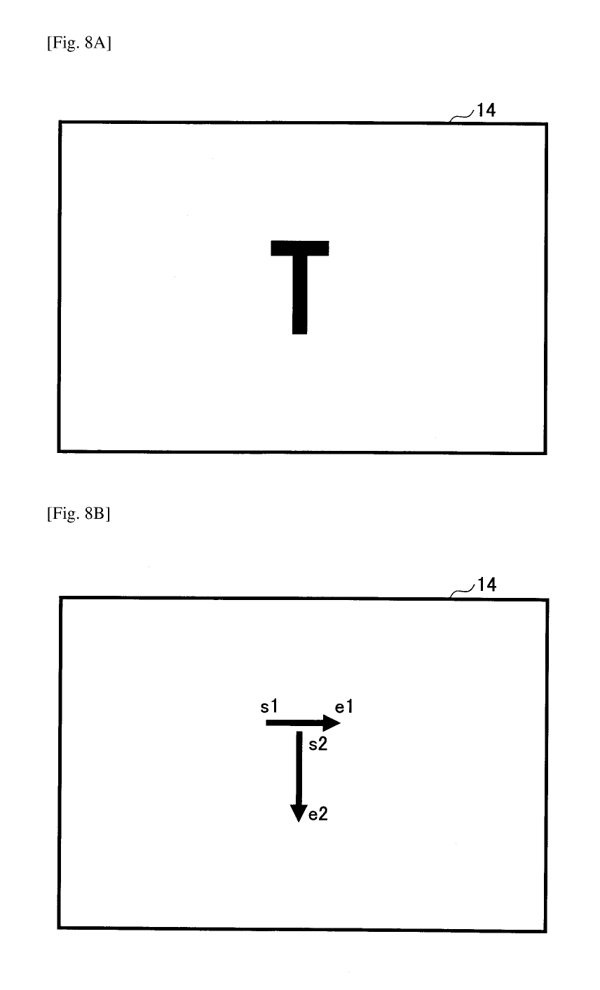

FIGS. 8A and 8B are diagrams illustrating an example of writing by the laser writing device WR according to the embodiment of the present invention. Specifically, as depicted, FIGS. 8A and 8B are diagrams illustrating the example where the laser writing device WR (FIG. 1) writes the character “T” of the alphabet on the thermosensitive recording medium 14.

Here, “T” is formed of two strokes, which are the horizontal line and the vertical line. Thus, for writing “T,” the laser writing device WR follows the two strokes, which are the horizontal line and the vertical line.

FIG. 8B is a diagram illustrating examples of a combination of a start point and an end point of a stroke, which are (s1, e1) and (s2, e2). First, the laser writing device WR adjusts a position of the laser beam by using the galvano minor 24, for example. The laser writing device WR moves the irradiation position to the first start point s1, without emitting the laser beam. Subsequently, the laser writing device WR starts emitting the laser beam (which may be simply referred to as “the laser is turned ON,” hereinafter). In this manner, the laser writing device WR writes from the first start point s1 to the first end point e1 by irradiating the laser beam onto the thermo-sensitive recording medium 14, while moving the irradiation position.

Next, the laser writing device WR stops emitting the laser beam (which may be simply referred to as “the laser is turned OFF,” hereinafter), and the laser writing device WR moves the irradiation position from the first end point e1 to the second start point s2, without emitting the laser beam. Subsequently, the laser writing device WR starts emitting the laser beam. In this manner, the laser writing device WR writes from the second start point s2 to the second end point e2 by irradiating the laser beam onto the thermo-sensitive recording medium 14, while moving the irradiation position. After writing the two strokes, the character “T” is written on the thermo-sensitive recording medium 14.

In this manner, for writing an intended character on the thermo-sensitive recording medium 14, the laser writing device WR may be controlled by an instruction, such as “the laser is turned ON from a first position to a second position, and the irradiation position is moved while emitting the laser beam.”

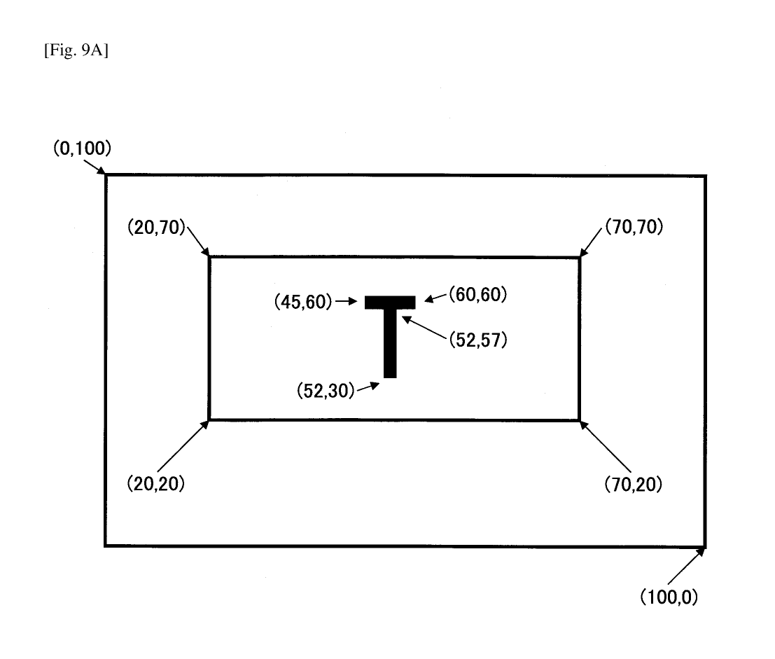

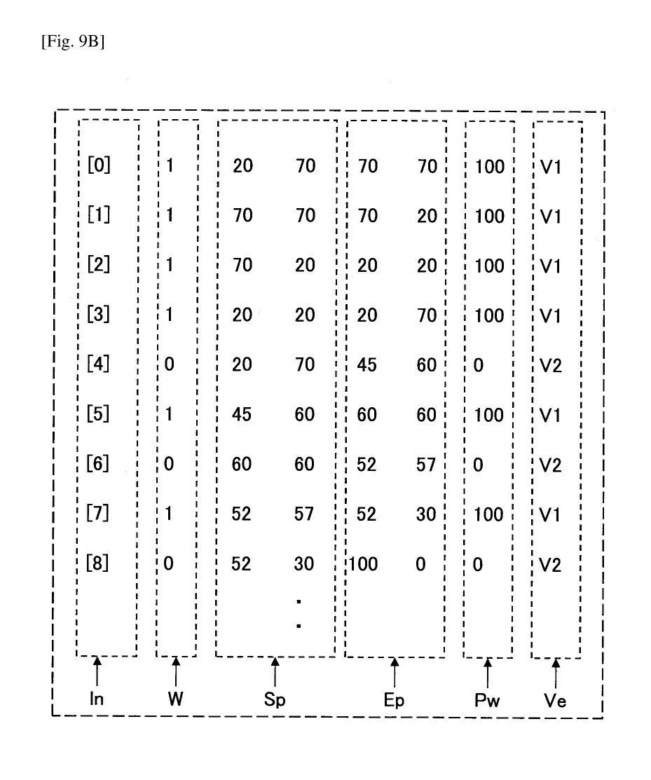

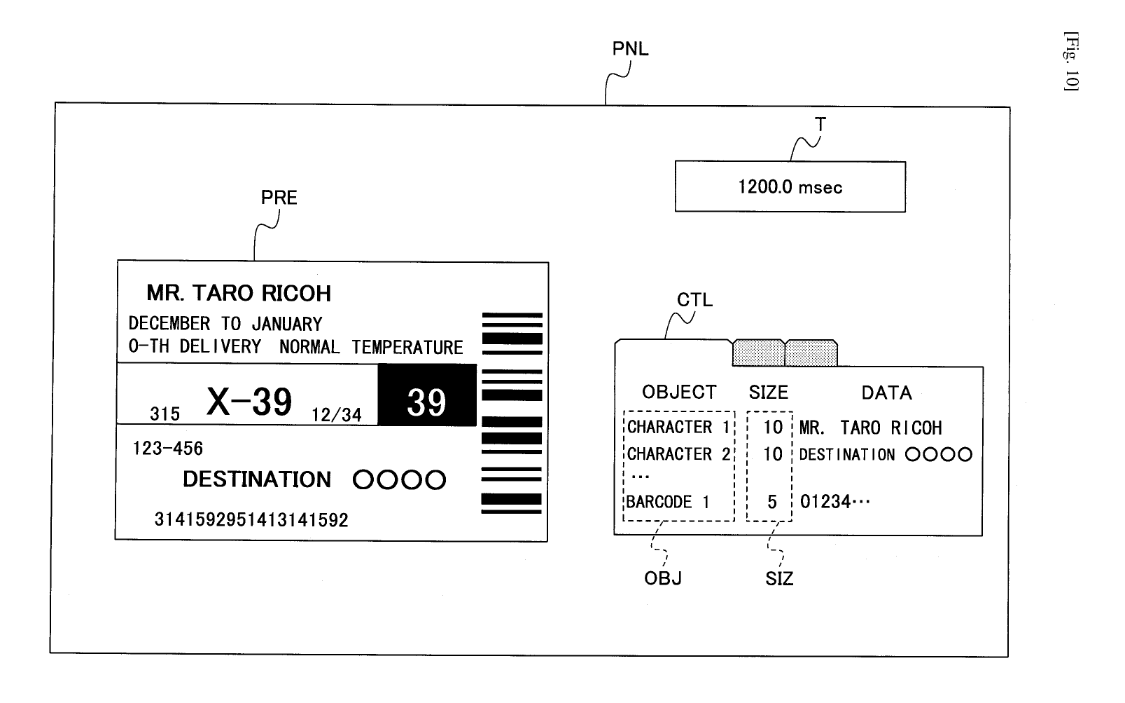

FIGS. 9A and 9B are diagrams illustrating an example of a scanning instruction that is used for the laser writing device WR according to the embodiment. Note that, in FIG. 9B, the scanning instruction indicates the following from the left.

ln: row number (stroke number)

W: ON/OFF of the laser (“1” indicates ON, and “0” indicates OFF)

Sp: coordinates of the start point

Ep: coordinates of the end point

Pw: output power of the laser

Ve: scanning speed

Here, coordinates are represented by (X, Y), where the horizontal direction is the X-axis, and the vertical direction is the Y-axis. Additionally, the value of X increases as the irradiation position moves to the right direction, and the value of Y increases as the irradiation position moves upward. Note that this arrangement of the coordinate system is for exemplifying purposes only. Thus, the scanning instruction is not limited to the examples of the instruction illustrated in FIG. 9B.

A laser writing device may be used, for example, in a factory or a distribution center, for writing destinations of products or product names, so as to convey and sort the products. Specifically, as illustrated in FIG. 1, in a factory, the thermo-sensitive recording medium 14 is attached to each of the containers to be sequentially conveyed by the conveyor 11. Subsequently, the laser writing device WR writes the character representing, for example, a destination on each of the thermo-sensitive recording media 14 by using the laser beam.

The character that is to be written on the thermo-sensitive recording medium 14 may always be fixed in a certain time interval. Alternatively, the character that is to be written on the thermo-sensitive recording medium 14 may be switched for each writing target. Thus, for the characters to be written, the PC 2, which is connected to the laser writing device WR through an Ethernet (registered trademark) card or RS-232C, for example, may often manage and control the writing data. Alternatively, the laser writing device WR may manage the writing data.

As illustrated in FIGS. 9A and 9B, the speed of writing by the laser writing device WR (which is referred to as the writing speed, hereinafter) differs from the speed of moving, by the laser writing device WR, the irradiation position to the position where next writing is to be executed, without emitting the laser beam (which is referred to as the moving speed, hereinafter). Thus, the writing time varies depending on whether writing of the character is to be executed.

In addition, the ratio between a time period of moving the laser writing device WR with the writing speed and a time period of moving the irradiation position with the moving speed varies depending on the type of the character. Thus, the writing time depends on the character. Furthermore, in FIG. 9B, the scanning speed Ve may differ (e.g., “V1” and “V2” in FIG. 9B) depending on the type of the character.

Moreover, the writing time changes as the layout is changed. For example, for a case of writing the same character, if the size of the character is enlarged, the area to be written is enlarged. Thus, the time period of moving the laser writing device WR with the writing speed is increased. Further, for the case of writing the same character, if the position on the thermo-sensitive recording medium 14 at which the character is written is changed, the start position of the writing is changed. Thus, the time period for moving, by the laser writing device WR, the irradiation position is changed. Furthermore, if the range of writing the character, namely, an area ratio is changed, the ratio of the area that is to be written is changed. Consequently, the ratio between the time period of moving the laser writing device WR with the writing speed and the time period of moving, by the laser writing device WR, the writing position with the moving speed is changed.

Based on the layout, the PC 2 calculates the writing time by using the scanning speed and the coordinates of the character, which are illustrated in FIG. 9. For example, upon determining a distance of writing from the coordinates and the scanning speed Ve from the type of the character, the PC 2 can calculate a time period required for writing each of the strokes. Here, the time period required for writing each of the strokes may be calculated, for example, by using a look up table (LUT), which is stored in the PC 2, in advance.

Thus, upon detecting that the writing data is changed, the PC 2 can calculate, for each of the thermo-sensitive recording medium 14, the writing time by adding the time period for writing the characters and the time period for moving, by the laser writing device WR, the irradiation position with the moving speed.

Here, the time period for moving the irradiation position is considered for calculating the writing time. However, in addition to the time period for moving, the time period for waiting prior to emitting the laser beam may be included in the writing time. Namely, in addition to the time period for moving, the time period for waiting may be used for calculation of the writing time. By including the time period for waiting, the writing time can be more accurately calculated.

Note that the scanning speed Ve illustrated in FIG. 9 may differ depending on the specification of the laser writing device WR. Thus, the PC 2 may retrieve the specification of each laser writing device WR from the corresponding laser writing device WR, and the PC may obtain, for each laser writing device WR, the writing speed and the moving speed based on the specification. In this manner, the PC 2 can accurately calculate the writing time.

(Example of Displaying the Writing Time (Step S03))

Referring back to FIG. 7, at step S03, the PC 2 displays the writing time. Specifically, upon detecting that the writing data is changed, the PC 2 displays, at step S03, the writing time calculated at step S02, prior to writing the character. Here, it is desirable to display the writing time each time the character or the layout is changed, instead of displaying the writing time as a pop-up message. In other words, it is desirable to display the writing time in real time.

(Example of a Determination of Whether the Character or the Layout is to be Changed (Step S04))

At step S04, the PC 2 determines whether the character or the layout is to be changed. Specifically, the PC 2 displays, to a user, a preview screen of writing, based on the character and the layout. Additionally, the PC 2 may simultaneously display the writing time (simultaneously execute the process of step S03). At step S04, the user decides whether writing is to be executed by viewing the preview screen and the writing time. Upon deciding, by the user, that writing is to be executed (NO at step S04), the process of the PC 2 proceeds to step S05.

In response to viewing the preview screen, the user may change the character or the layout. For example, if the size of the character is to be changed, the user operates the PC 2 to change the size of the character. In this case, if the user inputs, to the PC 2, an instruction to change the character or the layout, the process of the PC 2 proceeds to step S02 (YES at step S04).

(Example of Generating and Outputting the Writing Data (Step S05))

At step S05, the PC 2 generates the writing data, and the PC 2 outputs the writing data to the laser writing device WR. Specifically, the PC 2 generates the writing data, for example, by combining the scanning instructions illustrated in FIG. 9. Subsequently, the PC 2 outputs the generated writing data to the laser writing device WR. In response to receiving the writing data output from the PC 2, the laser writing device WR executes writing on the thermo-sensitive recording medium 14 based on the output writing data. Here, upon detecting that the writing data is output from the PC 2 (i.e., by using the fact that the writing data is output, as a trigger), the laser writing device WR may successively execute writing on the thermo-sensitive recording medium 14. Alternatively, by using, as a trigger, another instruction received after the writing data is output from the PC 2, the laser writing device WR may execute writing on the thermo-sensitive recording medium 14. Namely, the timing at which the laser writing device WR executes writing of the output writing data is not limited.

(Example of Displaying a Screen of the Whole Process)

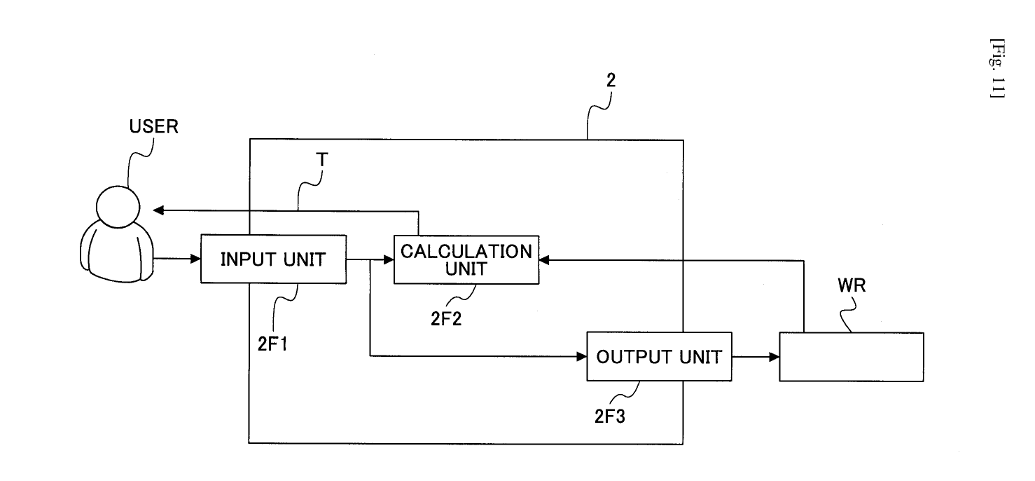

FIG. 10 is an example of displaying a screen of the whole process by the data generating device 2 according to the embodiment of the present invention. For example, the PC 2 (FIG. 1) displays a screen PNL to a user by using the graphic board 106 (FIG. 5) and the display 120 (FIG. 5).

For example, suppose that a user selects the character, which is desired to be written on the thermo-sensitive recording medium 14 (FIG. 1) by the laser writing device WR, and that the layout is changed by arranging the selected character (step S01 of FIG. 7). Here, the layout may indicate a design drawing or a design that defines, upon determining the position where the character is to be written, the size, and the range, how to arrange the character. For example, the layout may be displayed in a preview screen PRE.

Subsequently, upon detecting that the character and the layout are input, the PC 2 calculates the writing time based on whether the character is to be written, an order of writing the character, and the layout (step S02 of FIG. 7). Additionally, upon detecting that the character and the layout are input, the PC 2 displays the preview screen PRE, for example. Furthermore, the PC 2 displays the calculated writing time T (step S03 of FIG. 7).

The user changes the character and the layout by viewing the preview screen PRE (YES at step S04). Specifically, in FIG. 10, the character and the layout are changed by using the operation screen CTL, for example. Upon detecting that the portion of the object OBJ is clicked by the mouse 108 (FIG. 5), the PC 2 displays, for example, a pull-down menu indicating the type of the character, and the PC 2 prompts the user to select the type of the character. Next, upon detecting that the type of the character is selected, the PC 2 updates the preview screen PRE so that the selected type of the character is reflected, and the PC 2 calculates and updates the writing time T (steps S02 and S03 of FIG. 7).

Additionally, the layout may be updated by the user's operation to drag the portion of the preview screen PRE by using the mouse 108. Furthermore, the size of each character may be changed by the user by operating, with the mouse 108, the portion of the size SIZ indicating the size of each character.

Upon detecting that the character or the layout is changed in the screen PNL, the PC 2 calculates the writing time T (step S02 of FIG. 7), and the PC 2 displays the writing time T (S03 of FIG. 7). Thus, the user can find the writing time T, which is required for writing the character displayed on the preview screen PRE. Consequently, each time the writing data is changed, the user can find the updated writing time T.

It is desired that the writing time is less than or equal to a predetermined time period. For example, for a system which conveys 2400 pieces of containers 13 (FIG. 1) per hour, an upper limit time interval representing an upper limit of the writing time T may be “3600 seconds/2400 pieces=1.5 seconds/piece” for each container 13. In this case, it is desirable to set the upper limit time interval to be less than or equal to 1.0 second by considering, for example, the time for operating the conveyor 11, the time for communicating with each device, and the time interval between the timing of generating the instruction and the timing to start writing. Thus, if the user can find the writing time T prior to writing the character, the user can determine whether the writing time T exceeds the upper limit time interval. Furthermore, upon determining that the writing time T exceeds the upper limit time interval, the user can change the character or the layout, so that the writing time T is adjusted to be less than or equal to the upper limit time interval.

Upon detecting that the character or the layout is changed, the PC 2 displays the changed character or layout, for example, in the preview screen PRE. Additionally, as depicted, the PC 2 displays the preview screen PRE and the writing time T. Thus, the PC 2 can clearly indicate, to the user, how the writing time is changed in response to the input and the change.

At step S04, the writing time is displayed after determining whether the character or the layout is changed. However, this is not limited for the case of changing the character or the layout. For example, the writing time may be displayed again, based on the specification of the laser writing device WR.

If the writing speed is changed in accordance with the updated specification of the laser writing device WR, even if the character and the layout prior to updating the specification is the same as the character and the layout after updating the specification, the writing time may be changed due to the change in the writing speed. Thus, by displaying the writing time again, the PC 2 may inform the user that the writing time is changed due to the update of the specification.

Note that, in addition to the specification, the character and the layout are updated, the PC 2 may display the updated character and layout.

(Example of the Functional Configuration)

FIG. 11 is a functional block diagram illustrating an example of the functional configuration of the data generating device 2 according to the embodiment of the present invention. Specifically, the PC 2 includes, for example, an input unit 2F1; a calculation unit 2F2; and an output unit 2F3.

The input unit 2F1 is for inputting, to the PC 2, the character; and a layout that is defined by the position, the size, and the range of writing the character. For example, upon detecting that the user (USER) operates the screen PNL (FIG. 10), the input unit 2F1 obtains, from the screen PNL (FIG. 10), the information indicating the type of the character, the position where the character is to be written, the size of the character, and the range of the character; and the input unit 2F1 inputs, to the PC 2, the information indicating the type of the character, the position where the character is to be written, the size of the character, and the range of the character. Here, the input unit 2F1 may be implemented, for example, by the graphic board 106 (FIG. 5), the keyboard 107 (FIG. 5), the mouse (FIG. 5), and the display 120 (FIG. 5).

The calculation unit 2F2 calculates the writing time for writing by the laser writing device WR, based on whether the character is to be written, the order of writing the character, and the layout. Specifically, depending on whether the character is to be written, switching is made between the writing speed and the moving speed. In addition, the distance of writing with the writing speed and the distance of moving, by the laser writing device WR, the irradiation position with the moving speed are determined by the order of writing the character and the layout. Thus, the calculation unit 2F2 can calculate the writing time. The calculation unit 2F2 may be implemented, for example, by the CPU 101 (FIG. 5).

Additionally, the calculation unit 2F2 may retrieve, for example, the specification from the laser writing device WR through the network I/F 105 (FIG. 5); and the calculation unit 2F2 may obtain the writing speed and the moving speed from the specification of the laser writing device WR. Furthermore, the calculation unit 2F2 may display the calculated writing time T to the user (USER).

The output unit 2F3 generates the writing data based on the character and the layout; and the output unit 2F3 outputs the generated writing data to the laser writing device WR. The output unit 2F3 may be implemented, for example, by the network I/F 105.

The character and the layout are input to the PC 2 by the input unit 2F1. Subsequently, the calculation unit 2F2 of the PC 2 calculates, based on the input character and layout, time for writing each character, and time for moving the irradiation position to the coordinates, from which writing is to be started; and the calculation unit 2F2 calculates, based on the time for writing each character and the time for moving the irradiation position, the writing time. Consequently, upon detecting that the writing data is changed, the PC 2 can calculate the writing time, prior to writing the character.

(Another Embodiment)

In the following embodiment, similar to the above-described embodiment, the PC 2 illustrated in FIG. 5 is used as an example of the data generating device 2. Thus, the description of the hardware configuration is omitted. In the following, the points that are different from the above-described embodiment are mainly described. The whole process of this embodiment differs from the whole process of the above-described embodiment.

(Example of the Whole Process)

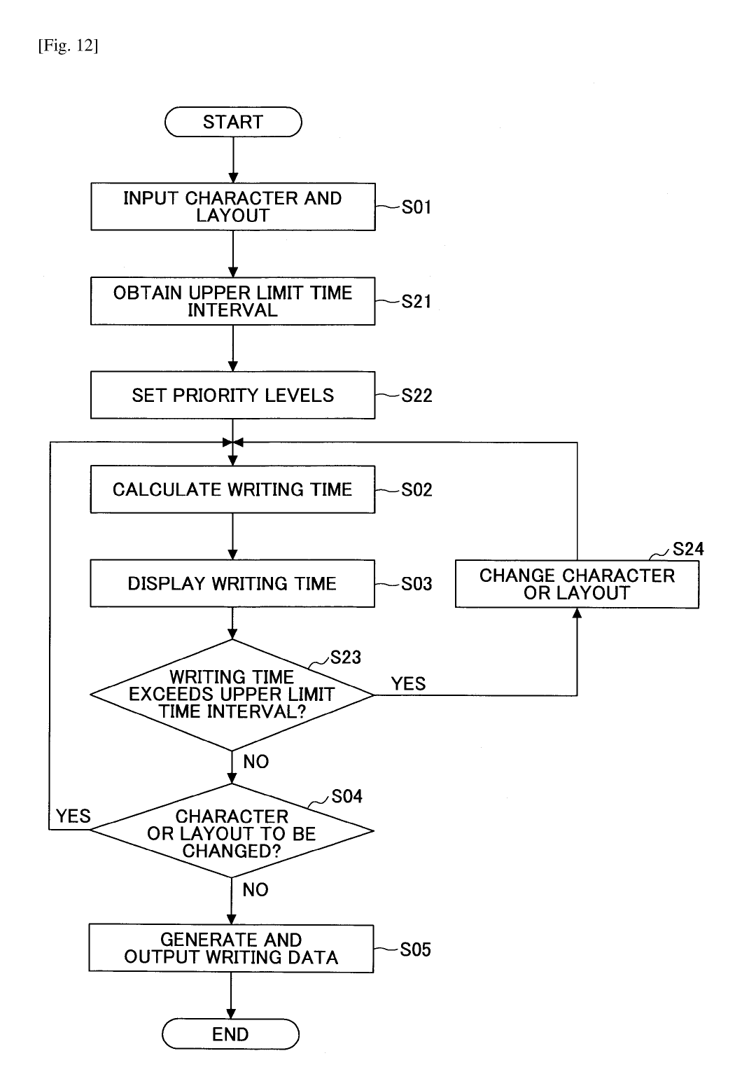

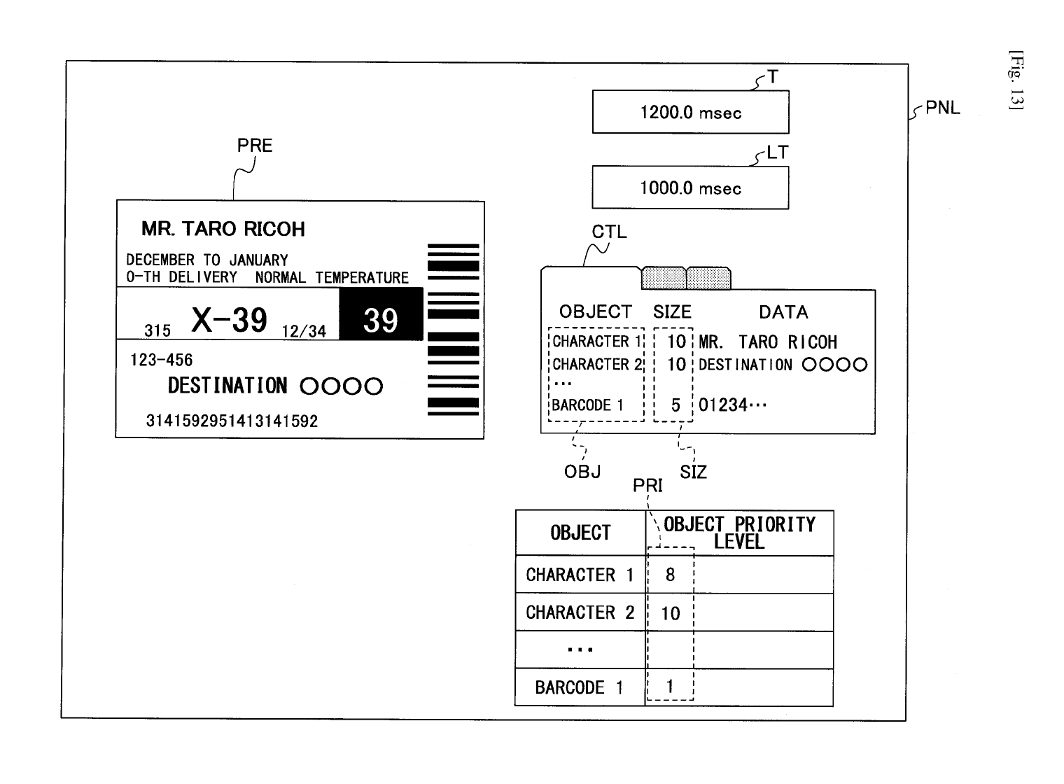

FIG. 12 is a flowchart illustrating an example of the whole process by the data generating device 2 according to the embodiment. In FIG. 12, the same reference numerals are attached to the processes that are the same as the corresponding processes of FIG. 7, and the descriptions of the processes are omitted. By comparing FIG. 7 with FIG. 12, it can be found that FIG. 12 differs from FIG. 7 in the point that steps S21-S24 are added.

(Example of Obtaining the Upper Limit Time Interval (Step S21))

At step S21, the PC 2 obtains the upper limit time interval. Specifically, at step S21, the PC 2 calculates the upper limit time interval, for example, from the number of the containers 13 (FIG. 1) processed by the information processing system 1 (FIG. 1) per unit time. Here, the user may input the upper limit time interval to the PC 2 by using the keyboard 107 (FIG. 5), for example.

(Example of Setting a Priority Level (Step S22))

At step S22, the PC 2 sets a priority level. Specifically, at step S22, for each character to be written, the PC 2 sets a priority level. Here, it is assumed that the priority level is defined in terms of a number, and that a smaller value represents a greater priority level. However, the method of defining the priority level is not limited to this.

The priority level may be defined by the PC 2 based on the preset information. Alternatively, the priority level may be input, by the user, for each layout.

(Example of a Determination as to Whether the Writing Time Exceeds the Upper Limit Time Interval (Step S23))

At step S23, the PC 2 determines whether the writing time exceeds the upper limit time interval. Specifically, at step S23, the PC 2 compares the writing time calculated at step S02 with the upper limit time interval obtained at step S21. Subsequently, upon determining, by the PC 2, that the writing time exceeds the upper limit time interval (YES at step S23) based on the result of the comparison, the process of the PC 2 proceeds to step S24. Whereas, upon determining, by the PC 2, that the writing time is less than or equal to the upper limit time interval (NO at step S23) based on the result of the comparison, the process of the PC 2 proceeds to step S04.

(Example of Changing the Character or the Layout (Step S24))

At step S24, the PC 2 changes the character or the layout. Specifically, at step S24, the PC 2 selects, among the characters to be written, the character with the lowest priority level, which is set at step S22. Next, the PC 2 changes the selected character. For example, the PC 2 reduces the size of the character.

When the size of the character is reduced, in many cases, the area to be written is reduced. In many cases, the writing speed is smaller than the moving speed. Thus, in many cases, if the area to be written is reduced, the writing time is reduced.

Thus, PC 2 may make the writing time shorter by reducing the size of the character. Similarly, the PC 2 may make the writing time shorter by changing the layout. Thus, the PC 2 can reduce the writing time by changing the layout.

Namely, the PC 2 can reduce the writing time by changing the character or the layout. Thus, the PC 2 can reduce the writing time, so that the writing time is less than or equal to the upper limit time interval. Additionally, upon detecting that the character or the layout is changed, the PC 2 further executes the process of step S02 and step S03 to display, to the user, the writing time and the preview screen PRE.

Here, if the writing time is less than the upper limit time interval, the PC 2 may change the character or the layout. Namely, the case where the writing time is less than the upper limit time interval is the case where there is sufficient writing time. Thus, the PC 2 may enlarge the size of the character having a large priority level.

In many cases, the character having a large priority level indicates information that is important for a relevant person. Thus, it is desirable that the character having a large priority level is written in a large size. When the character is written in a large size, the character tends not to be collapsed, so that a reading device or a relevant person can easily read the character.

In the whole process illustrated in FIG. 12, upon determining, by the PC 2, that the writing time exceeds the upper limit time interval at step S23 (YES at step S23), the PC 2 changes the character or the layout at step S24. However, the embodiment is not limited to this.

For example, in addition to the determination at step S23, the PC 2 may determine the number of the objects arranged in the current layout and an instruction from the user as to whether the layout is allowed to be changed. Then, the PC 2 may determine whether the process of the PC 2 is to proceed to step S24.

(Example of Displaying the Screen of the Whole Process)

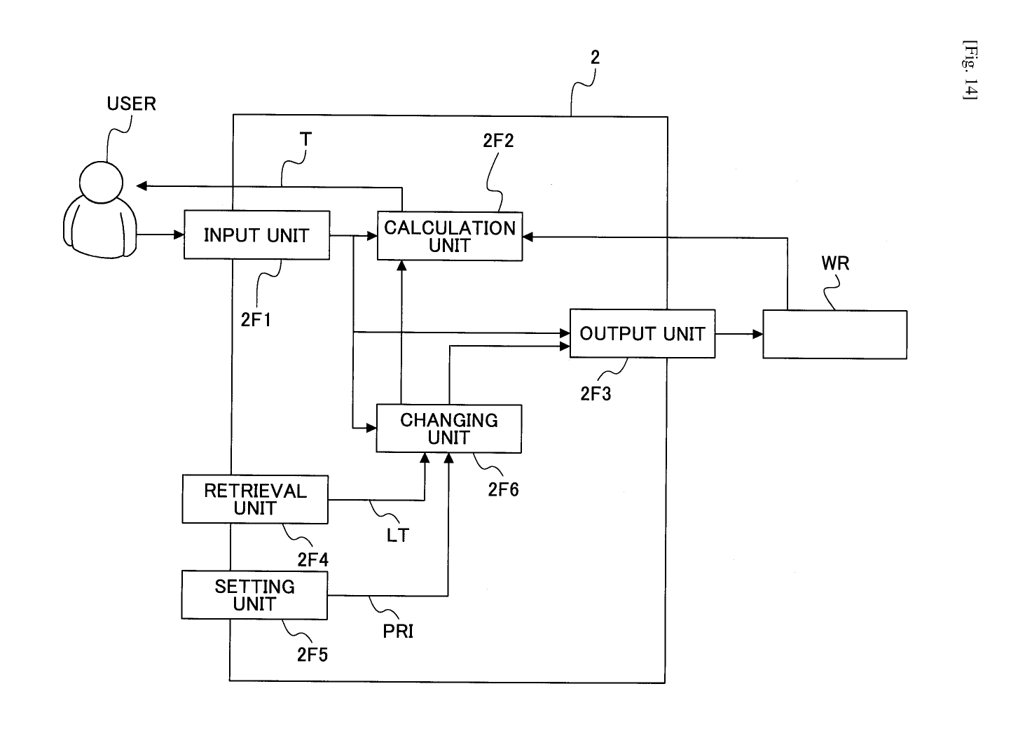

FIG. 13 is a diagram illustrating an example of displaying a screen of the whole process by the data generating device according to the embodiment. For example, in addition to the screen PNL depicted in FIG. 10, the PC 2 (FIG. 1) displays, to the user, a GUI indicating the priority level PRI and and the upper limit time interval LT. Note that, similar to FIG. 10, the writing time T can be calculated and displayed (step S02 and step S03 of FIG. 12).

Upon detecting that the writing time T, which is calculated based on the character and the layout input by the user, exceeds the upper limit time interval LT (YES at step S23 in FIG. 12), the PC 2 changes the character or the layout (step S24 in FIG. 12).

The change of the character or the layout is executed based on the defined priority level PRI. For example, in FIG. 13, the PC 2 changes the size SIZ of the “character 2” having the greatest priority level PRI value, i.e., having the smallest priority level PRI. Namely, the PC 2 changes the character or the layout, while fixing the size of the character having a small priority level PRI value, i.e., having a large priority level PRI. If the writing time T is less than the upper limit time interval LT, the PC 2 may change the size SIZ of the “barcode 1” having the smallest priority level PRI value, i.e., having the largest priority level PRI.

The character having a large priority level PRI may represent a destination, which may often be written in Chinese characters. When Chinese characters are written in a small size, the characters tend to be collapsed. Thus, it is desirable that Chinese characters are written in a large size. Additionally, a barcode can be an example of a character having a large priority level PRI. In order to read the barcode by a reading device, it may be required that the barcode is written in a certain size. In many cases, if a barcode is written in a large size, a reading device can easily read the barcode. Thus, it is desirable that priority levels PRI of a Chinese character and a barcode are set to be large, and that the Chinese character and the barcode are written in a large size.

Here, the PC 2 may change a plurality of characters. For example, first, the PC 2 may change the character having the lowest priority level PRI, and then the PC 2 may sequentially change the characters in an ascending order of the priority level PRI. Similarly, for changing a character having a large priority level PRI, the PC 2 may sequentially change the characters in a descending order of the priority level PRI.

In FIG. 13, the priority levels are individually set to corresponding objects, such as the “character 1” and the “character 2.” However, the method of setting the priority level is not limited to this. For example, a priority level may be collectively set to a type of objects, such as the character, or the figure.

The PC 2 calculates the writing time, and the PC 2 updates the preview screen PRE and the writing time T to reflect the change of the character or the layout.

(Example of the Functional Configuration)

FIG. 14 is a functional block diagram illustrating an example of the functional configuration of the data generating device according to the embodiment of the present invention. Specifically, the PC 2 includes, for example, an input unit 2F1; a calculation unit 2F2; an output unit 2F3; a retrieval unit 2F4; a setting unit 2F5; and a changing unit 2F6. By comparing FIG. 14 with FIG. 11, which illustrate the functional configuration of the data generating device 2 according to the above-described embodiment, it can be seen that FIG. 14 differs from FIG. 11 in a point that the retrieval unit 2F4, the setting unit 2F5, and the changing unit 2F6 are added. In FIG. 14, the same reference numerals are attached to the functions that are the same as the corresponding functions of the above-described embodiment, and the description of the functions is omitted. In the following, the points that are different from FIG. 11 are mainly described.

The retrieval unit 2F4 obtains the upper limit time interval LT. The retrieval unit 2F4 may be implemented, for example, by the CPU 101 (FIG. 5), the keyboard 107 (FIG. 5), the mouse 108 (FIG. 5), and the display 120 (FIG. 5).

The setting unit 2F5 sets the priority level PRI of the character. The setting unit 2F5 may be implemented, for example, by the keyboard 107, the mouse 108, and the display 120.

The changing unit 2F6 changes, upon detecting that the writing time T exceeds the upper limit time interval LT, the size of the character having a small priority level PRI, so that the size the character is reduced, for example. Additionally, the changing unit 2F6 may change, upon detecting that the writing time T is less than the upper limit time interval LT, the size of the character having a large priority level PRI, so that the size of the character is enlarged, for example. The changing unit 2F6 may be implemented, for example, by the CPU 101.

The PC 2 obtains the upper limit time interval LT by using the retrieval unit 2F4. The input unit 2F1 inputs a character and a layout to the PC 2. Then, in the PC 2, the calculation unit 2F2 calculates the writing time by calculating the time for writing each character and the time for moving the irradiation position to the coordinates, from which writing is started, based on the input character and layout. Thus, the PC 2 can calculate, in response to detecting that the writing data is changed, the writing time T prior to writing the character.

Further, the PC 2 compares the writing time T with the upper limit time interval LT. Additionally, in the PC 2, the setting unit 2F5 sets, for each character, a priority level PRI. Thus, the PC 2 can detect a character having a small priority level.

Upon detecting that the writing time T exceeds the upper limit time interval LT, the changing unit 2F6 of the PC 2 changes the size of the character having the small priority level PRI, so that the size of the character is reduced, for example. For a layout where the size of the character is small, the writing time tends to be short. Thus, the PC 2 can generate the writing data for which the writing time T is less than or equal to the upper limit time interval LT.

In many cases, in the information processing system 1 (FIG. 1), the writing time T is restricted. Thus, if an upper limit of the writing time T required for writing on a recording medium is defined as the upper limit time interval LT, the PC 2 can generated writing data, which can be written by the laser writing device WR within a time interval that is less than or equal to the upper limit time interval LT.

Additionally, by setting the priority level PRI, a failure can be prevented from occurring, in which the written character is collapsed. According to the embodiment, the PC 2 generates the writing data. Thus, an amount of tasks of the user to change the type of the character or the layout can be reduced. Thus, by the PC 2, the workload of the user can be reduced.

Note that a part of or all the process of the embodiment of the present invention may be implemented by a program to be executed by a computer, which is described in a legacy programming language, such as assembler, C, C++, C#, and Java (registered trademark), or an object-oriented programming language. Namely, the program is a computer program for causing a computer, such as a data generating device or an information processing system including a data generating device, to execute each process.

Further, a program may be stored in a computer readable storage medium, such as a ROM or an Electrically Erasable Programmable ROM (EEPROM); and the program may be distributed by distributing the computer readable storage medium. Furthermore, the storage medium may be a Erasable Programmable ROM (EPROM), a flash memory, a flexible disk, a CD-ROM, a CD-RW, a DVD-ROM, a DVD-RAM, a DVD-RW, a Blue-ray disk, a SD (registered trademark) card, or a MO. Moreover, the program may be distributed through a telecommunication line.

Furthermore, the information processing system 1 may include two or more information processing devices that are mutually connected through a network. The plurality of information processing devices may execute a part of or all the process in a distributed manner, in a parallel manner, or in a redundant manner.

A data generating device, a data generating method, and a data generating program that can calculate, in response to detecting that writing data is changed, writing time prior to writing a letter, a number, a figure, a symbol, a barcode, a two-dimensional code, or a combination thereof are described above by the embodiments. However, the present invention is not limited to the embodiments, and various modifications and improvements may be made within the scope of the present invention. Specific examples of numerical values are used in order to facilitate understanding of the invention. However, these numerical values are simply illustrative, and any other appropriate values may be used, except as indicated otherwise. The separations of the items in the above-described explanation are not essential to the present invention. Depending on necessity, subject matter described in two or more items may be combined and used, and subject matter described in an item may be applied to subject matter described in another item (provided that they do not contradict). A boundary of a functional unit or a processing unit in a functional block does not necessarily correspond to a boundary of a physical component. An operation by a plurality of functional units may be physically executed by a single component. Alternatively, an operation by a single functional unit may be physically executed by a plurality of components. For the convenience of explanation, the devices according to the embodiment of the present invention are explained by using the functional block diagrams. However, these devices may be implemented in hardware, software, or combinations thereof. The software that operates in accordance with the present invention may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like.

The present invention can be implemented in any convenient form, for example using dedicated hardware, or a mixture of dedicated hardware and software. The present invention may be implemented as computer software implemented by one or more network processing apparatuses. The network can comprise any conventional terrestrial or wireless communications network, such as the Internet. The processing apparatuses can compromise any suitable programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a CD ROM, a magnetic tape device or a solid state memory device. The hardware platform includes any desired hardware resources including, for example, a central processing unit (CPU), a random access memory (RAM), and a hard disk drive (HDD). The CPU may include processors of any desired kinds and numbers. The RAM may include any desired volatile or non-volatile memories. The HDD may include any desired nonvolatile memories capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Applications No. 2015-055416 filed on Mar. 18, 2015, and No. 2016-003740 filed on Jan. 12, 2016, the entire contents of which are hereby incorporated by reference.

### REFERENCE SIGNS LIST

1: INFORMATION PROCESSING SYSTEM

2: PC

RD 1, RD 2: READER

WR, WR2: LASER WRITING DEVICE

13: CONTAINER

14: THERMO-SENSITIVE RECORDING MEDIUM

T: WRITING TIME

LT: UPPER LIMIT TIME INTERVAL

PRI: PRIORITY LEVEL

### CITATION LIST

### Patent Literature

[PTL 1] Patent Document 1: Japanese Unexamined Patent Publication No. 2014-156119

1. A data generating device for generating writing data, the data generating device being connected to a writing device for writing a character on a recording medium based on the writing data, the data generating device comprising:
an input unit configured to input the character and a layout, the layout being defined by a position, a size, and a range of writing the character;
a calculation unit configured to calculate, in response to detecting that the character or the layout is changed, a writing time for writing by the writing device based on whether the character is to be written, an order of writing the character, and the layout;
an output unit configured to generate the writing data based on the character and the layout, and configured to output the generated writing data to the writing device;
a retrieval unit configured to obtain an upper limit time interval representing an upper limit of the writing time,
a setting unit configured to set a priority level of the character; and
a changing unit configured to change a character with a small priority level,
wherein the data generating device is configured to determine whether the writing time is less than the upper limit time interval, and
wherein, upon detecting, by the data generating device, that the writing time exceeds the upper limit time interval, the changing unit is configured to reduce a size of the character with the small priority level.

2. The data generating device according to claim 1, wherein the layout is further defined by a writing condition, and
wherein the writing condition includes writing speed of writing by the writing device, and a setting value for setting speed of writing a predetermined character included in the character.

3. The data generating device according to claim 1, wherein the character represents a letter, a number, a figure, a symbol, a barcode, a two-dimensional code, or a combination thereof.

4. The data generating device according to claim 1, wherein the writing device is configured to write the character on the recording medium by irradiation of a laser beam, by a heated head, or by engravement.

5. The data generating device according to claim 1, wherein the data generating device is configured to retrieve, from the writing device, a specification of the writing device, and
wherein the data generating device is configured to obtain, based on the specification, writing speed of writing by the writing device, and a moving speed of moving the writing device to a position at which the character is to be written.

6-8. (canceled)

9. The data generating device according to claim 1, wherein the changing unit is further configured to change, upon detecting that the writing time is less than the upper limit time interval, a character with a large priority level.

10. The data generating device according to claim 9, wherein the changing unit is configured to enlarge or fix a size of the character with the large priority level.

11. The data generating device according to claim 1, wherein the calculation unit is configured to calculate the writing time, upon detecting that at least one of the character, the layout, a specification of the writing device, and a combination thereof is changed.

12. The data generating device according to claim 1, wherein the data generating device is configured to display the writing time, upon detecting that at least one of the character, the layout, and a specification of the writing device is changed.

13. The data generating device according to claim 12, wherein the data generating device is further configured to display, upon detecting that the character or the layout is changed, the changed character and the changed layout.

14. A data generating method to be executed by a data generating device for generating writing data, the data generating device being connected to a writing device for writing a character on a recording medium based on the writing data, the data generating method comprising:
a step of inputting, by the data generating device, the character and a layout, the layout being defined by a position, a size, and a range of writing the character;
a step of calculating, by the data generating device, a writing time for writing by the writing device based on whether the character is to be written, an order of writing the character, and the layout, in response to detecting that the character or the layout is changed;
a step of generating, by the data generating device, the writing data based on the character and the layout, and outputting, by the data generating device, the generated writing data to the writing device;
a step of obtaining, by the data generating device, an upper limit time interval representing an upper limit of the writing time,
a step of setting, by the data generating device, a priority level of the character; and
a step of changing, by the data generating device, a character with a small priority level,
wherein, upon detecting, by the data generating device, that the writing time exceeds the upper limit time interval, the step of changing reduces a size of the character with the small priority level.

15. A non-transitory recording medium storing a data generating program for causing a computer to generate writing data, the computer being connected to a writing device for writing a character on a recording medium based on the writing data, the data generating program causing the computer to execute:
a step of inputting, by the computer, the character and a layout, the layout being defined by a position, a size, and a range of writing the character;
a step of calculating, by the computer, a writing time for writing by the writing device based on whether the character is to be written, an order of writing the character, and the layout, in response to detecting that the character or the layout is changed;
a step of generating, by the computer, the writing data based on the character and the layout, and outputting, by the computer, the generated writing data to the writing device;
a step of obtaining, by the computer, an upper limit time interval representing an upper limit of the writing time,
a step of setting, by the computer, a priority level of the character; and
a step of changing, by the computer, a character with a small priority level,
wherein, upon detecting, by the computer, that the writing time exceeds the upper limit time interval, the step of changing reduces a size of the character with the small priority level.
